(19) United States
(12) Patent Application Publication
(10) Pub. No.: US 2008/0244736 A1
(43) Pub. Date: Oct. 2, 2008

(54) MODEL-BASED ACCESS CONTROL

(75) Inventors: Butler Lampson, Cambridge, MA (US); Ravindra Nath Pandya, Clyde Hill, WA (US); Paul J. Leach, Seattle, WA (US); Muthukrishnan Paramasivam, Seattle, WA (US); Carl M. Ellison, Seattle, WA (US); Charles William Kaufman, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/694,014

(22) Filed: Mar. 30, 2007

(51) Int. Cl. G06F 12/14

(52) U.S. Cl. 726/21

(57) ABSTRACT

Access control as it relates to policies or permissions is provided based on a created model. A security policy is abstracted and can be independent of a mechanism used to protect resources. An asbstract model of a potential user, user role and/or resource is created without associating a specific individual and/or resource with a model. These abstract user models and abstract resource models can be used across applications or within disparate applications. The abstracted security policies can be selectively applied to the model. Specific users and/or resources can be associated with one or more abstract user model or abstract resource model. The models can be nested to provide configurations for larger systems.

### BACKGROUND

Computers and computer systems are widely utilized in a multitude of environments (e.g., business, personal, and so forth). Individuals that perform functions with computers and/or computer systems (e.g., create, modify, store, delete, data entry, and so on) generally are provided access rights that allow the individual to perform various functions or use various applications but does not allow other functions to be performed and/or applications to be utilized. For example, a supervisor might be given access to modify employee records and to view employee compensation packages while a subordinate might not be given access to these types of information.

Administrators and other users of a computer system can utilize an infrastructure to implement and mange the various access rights. This requires access permissions to be configured for a multitude of resources and a multitude of individuals. Configuring the disparate computers, settings, and other information is not only time consuming but also requires the administrator to remember each setting. In addition, the administrator should provide similar individuals (e.g., individuals performing the same work function) with similar, if not identical, access rights. As changes are made to each individual's access rights, the original intent of such access rights might be lost as a result of errors occurring when access rights are created and/or modified, or as a result of a number of incorrect changes being made in order to create a desired access right setting, especially when initially it is not known how to manipulate the setting. Thus, users performing a similar function might have different access rights, which can potentially cause problems, especially if a user has access to something that they should not have access to.

Thus, access management today involves configuring low-level settings specific to resource managers and has little resemblance to the “intent” of the policy author. Such settings are difficult to maintain and hard to reconcile with the policy intent once the configuration is complete. Moreover, when the same policy is to be applied repeatedly over many domains, it requires that low-level configurations be made repeatedly. This is expensive to manage, and furthermore offers little support in the form of querying and comprehending the configured policy with regard to the intent.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with model-based access control and permission rights. An abstract user role model and/or an abstract resource model are created that can be modular and utilized across many different applications. Abstracted security policies can be associated with each user role model, making such model and associated access rights uniform for a particular role or function. A specific individual or more than one individual can be associated with each user role model and permissions granted to such individuals can be based on the permissions granted to the user role model.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system that provides model-based access control.

FIG. 2 illustrates a system that can facilitate model-based access control.

FIG. 3 illustrates a view of a model for a subset of a system.

FIG. 4 illustrates an exemplary manual administration of assigning access rights to a multitude of users.

FIG. 5 illustrates an exemplary system that can be utilized with the disclosed embodiments.

FIG. 6 illustrates another system that can be utilized with the disclosed embodiments.

FIG. 7 illustrates the extensible nature of the disclosed embodiments.

FIG. 8 illustrates a simplified template for a family personal computer or domain.

FIG. 9 illustrates a method for providing a model based access control that is modular.

FIG. 10 illustrates a block diagram of a computer operable to execute the disclosed embodiments.

FIG. 11 illustrates a schematic block diagram of an exemplary computing environment operable to execute the disclosed embodiments.

### DETAILED DESCRIPTION

Various embodiments are now described with reference to the drawings. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

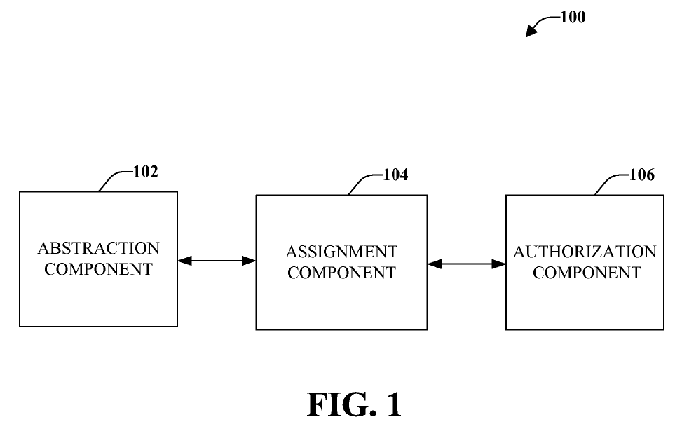

Referring initially to FIG. 1, illustrated is a system 100 that provides model-based access control. System 100 provides a security policy that can be abstracted from resource manager primitives and can specify a policy with higher-level abstractions that can mirror the intent of a policy author. Additionally or alternatively, system 100 can facilitate creating and applying multiple instances of a security policy across a variety of different authorization contexts. System 100 can further be configured to specify a security policy in nested models.

When an administrator or other person responsible for controlling access to and protecting resources configures access permissions for a variety of resources and a multitude of people, it can become difficult to configure the low-level settings directly on the resources themselves. There can also be a management problem when there are a large number of resources for which a user should have permission to access. These resources can be anything where there are applications that can be loaded (e.g., file shares, share point sites, access to traditional applications, and so on). Sometimes access control configuration is performed by modifying various settings of the underling authorization mechanisms without understanding or appreciating the ramifications of such modifications or the policy involved. Generally, a configuration cannot be copied from one context to another context but must be manually reconfigured. This may or may not result in the same configuration especially if there are errors in one or more of the configuration set points. This can lead to problems such as where there are compliance issues and other regulatory forces that expect information relating to the exact enterprise access management policies. System 100 can be configured to maintain the policies and preserve such policies to a group of users that have substantially the same access rights.

In further detail, system 100 includes an abstraction component 102 that can be configured to abstract from underlying implementations of various applications and parameters a security policy to protect resources. Based in part on the security policy, abstraction component 102 can build one or more abstract user models, one or more abstract resource models, or both abstract user models and abstract resource models. The abstract user model might be an abstract of a particular user role or another means of identifying similar users that should have access to similar resources to create a model (e.g., manufacturing supervisor, bank teller, toll-road booth operator, librarian, and so forth). The abstract user model might be a model of an organization of resources and users. For example, it can be a hierarchy of resources (or scopes) related to a hierarchy of users in a group.

Abstraction component 102 can be independent of the type of mechanism or configuration actually used to protect resources (e.g., programs, applications, formats, files, and so forth) and/or the user the actually accesses the resources. For example, regardless of the mechanism utilized, persons that need access to financial documents should be allowed access to those financial documents. Through utilization of abstraction component 102, an administrator or other person responsible for persisting a security policy does not have to manually perform low-level configuration for each user and/or resource but may modify the user model and/or the resource model.

Additionally, abstraction component 102 can be configured to help preserve the policy intent. Since the security policy is abstracted from the resource management primitive, an abstraction can be provided that can allow policy authors to specify one or more policies in a manner that is closer to the actual intent (e.g., such as a codified intent) rather than the underlying implementation that protects the resources.

Additionally, abstraction component 102 can be configured to provide repeatability of the abstract model configuration. In such a manner, the abstract models (e.g., user, resource) can be modular and can be applied across different applications or through various and disparate roles and functions. For example, a national bank might have branches and would like to ensure that each branch has the same kind of configuration (e.g., a manager has more permissions than an assistant manager and a teller has low-level permissions). These resources, roles and associated permissions are the same for each branch, although a different person is performing the corresponding function (e.g., manager, teller). Thus, repeatability of the permission configuration can be persisted through all the branches.

An assignment component 104 can be configured to identify or designate one or more specific users to an abstract user model or to more than one abstract user model For example, a role can be a bank teller, a bank supervisor, a machine shop foreman, a receptionist, a child, an adult, and so forth. Assignment component 104 can be configured to maintain information relating to why a user role or group of user roles has access to certain permissions and/or can translate an abstract model into concrete terms thereby assigning permissions to the users for use of the concrete resources. Assignment component 104 can further be configured to assign one or more resources to the abstract resource models.

Also included in system is an authorization component 106 that can be configured to set permissions (e.g., name specific users/groups with their rights) on the concrete resources based in part on the model. At substantially the same time as the user is identified and placed into the desired group or groups, the appropriate permissions and memberships can be automatically created as a consequence of identifying the user with a particular user model.

Additionally, authorization component 106 can be configured to maintain information relating to why a specific individual has access to various permissions. If a user performs different roles, the user can be given permissions relating to each of those roles, depending on the task being performed. For example, if the user is a receptionist but also fills in when the payroll clerk is out, this user might have both permissions (receptionist and payroll clerk). However, if the user is not covering for the payroll clerk, the permissions relating to payroll functions can be disabled and only the receptionist permissions are allowed during those times.

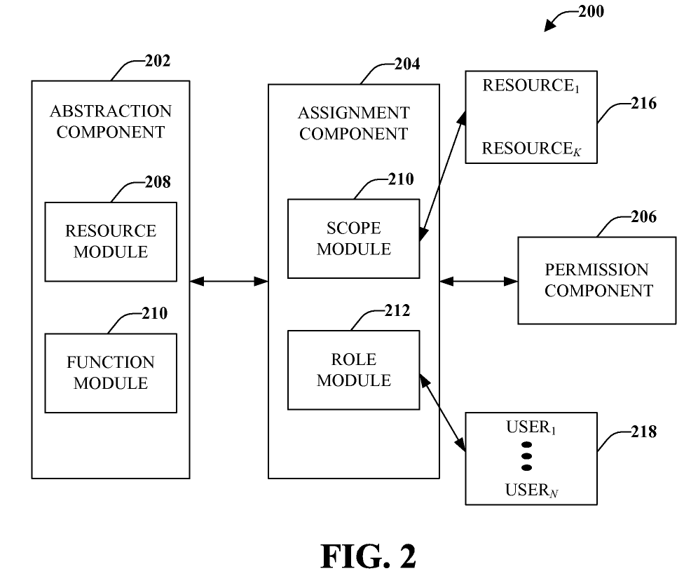

FIG. 2 illustrates a system 200 that can facilitate model-based access control. System 200 can be configured to simplify an authorization policy and implementation of that authorization policy. There can be a multitude of security knobs (e.g., privileges, resource names, and so one) on each computer. In a large installation there can be hundreds or thousands of computers, which would make it very difficult, if not impossible, to manually configure and monitor these settings. System 200 can be configured to conceal the complexity of the underlying implementation from users and administrators. In some embodiments, users and administrators can access the underlying implementation if desired.

System 200 can mitigate repetitive manual effort by an administrator when complex policies apply to multiple objects. System 200 can also retain information relating to a policy, making it possible to determine the parameters of the policy even if there has been a long history of incremental changes.

System 200 includes an abstraction component 202 that can be configured to abstract or conceptualize from underlying implementations of various applications and parameters a security policy to protect resources and to create abstract user models, abstract resource models, or both models. Also included is an assignment component 204 that can be configured to correlate the abstracted security policies and a user model with a specific user or users and a resource model with a specific resource or resources. Also included in system 200 is a permission component 206 that can be configured automatically set permissions on the specific resources based on the model.

Abstraction component 202 can include a resource module 208 and a function module 210 that independently or in conjunction acquire a model of the various resources, users and permissions as viewed by an administrator. Resource module 208 can include information relating to the various resources available and create an abstract resource model based on such available resources. Function module 210 can include information relating to the potential roles (e.g., user) through which people can have access (e.g., human resource manager, stock clerk, and so forth). Abstraction component 202 can (e.g., through resource module 208 and/or function module 208) provide a mechanism or vocabulary that allows the model to be specified in abstract terms.

For example, there can be an abstract resource, such as the Emerald project and there are project facilitators that should have various accesses because of their role as facilitations. Thus, abstraction component 202 does not focus on specific resources being protected but on a conceptual organization of these resources and a conceptual organization of users and the kinds of permissions for each user on the resources.

Assignment component 204 can include a scope module 212 and a role module 214. The scope module 212 can include or can access a collection of resources and a subset of these resources can be assigned to one or more abstract resource models 216, labeled Resource₁ through Resource_{K}, where K is an integer. Also included is a role module 214 that can access or maintain a collection of principals that can be assigned to one or more abstract user models. These principles can be users 218 or a user roles, labeled User₁ through User_{N}, where N is an integer. The model created by system 200 can be populated with specific users and/or resources (e.g., disk files, databases, other things specified in the model).

It should be understood that there are other ways by which a model can be represented and roles and scopes are just one example of representing the model. Thus, no matter the mechanism or vocabulary used, the resources and user groups or roles can be defined based on the relationship they have with each other. The permissions can be specified based on those primitives instead of the actual physical resource and real users.

There can be a first person abstracting the system, another person instantiating the abstracted or conceptual organization to specific resources and another person adding users to the appropriate tools. Therefore, these resources can be conveyed in an independent manner from the intent and there can be complicated relations that are instantiated in different contexts.

Additionally, the modular concepts can be configured to create nested models. Security policies can be specified in these nested modules. A model can be specified for access control and that model can be used as a component in building models for bigger systems.

Since the roles are generic or abstract, models can be used in other models or sub-models and used in a modular manner. For example, there can be templates for each bank branch and a head branch in each city. There can be a model specifying who is allowed to designate a back-up manager. However, the branch itself is not modeled or invented to describe the branch. Instead, a branch model already built can be reused and combined with the back-up manager module.

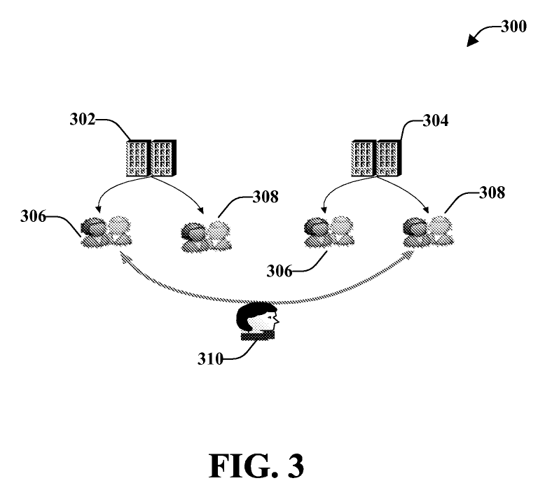

FIG. 3 illustrates a view of a model 300 for a subset of a system. This model view 300 can be from the perspective of an administrator, a user and/or entity that is responsible for assigning specific individuals to specific roles or accesses (e.g., security accesses). Illustrated are two project repositories 302 and 304, which can represent two projects being worked on concurrently within an organization. In some embodiments, the repositories 302, 304 can represent other items, jobs, tasks, and so forth that have a multitude of users that should be assigned different access rights as it relates to the item, jobs, tasks, and so on. These repositories 302, 304 can be scopes for resources, one for the first project 302 and one for the second project 304.

Each project 302, 304 can have various roles or a logical class of users assigned to perform various functions at it relates to the project 302, 304. For example, the first project 302 has two roles, which can be developers 306 and project managers 308. In this simple example, the second project 304 also has two similar roles, developers 306 and project managers 308. However, it should be understood that there can be a multitude of roles, and two are illustrated for purposes of simplicity. Additionally or alternatively, more than one user can be assigned to each role and the roles can be utilized across repositories 302, 304, as represented by roles 306 and 308. When deploying a project repository 302, 304, a group for each role can be created. This group can include users who are performing the functions of that role for the project. Thus, a scope is a collection of resources and a role is a collection of principals.

In this simple illustration, an administrator (or other responsible party) places a user 310 into the desired group or groups and the appropriate permissions and memberships are automatically created as a consequence of identifying the user 308 with a particular role 306, 308. That is to say, for each repository 302, 304, a multitude of roles 306 and 308 can be assigned, which may be different roles and/or a different number of roles than those illustrated and described. One or more individuals are assigned to each role and the corresponding access rights for that role are applied to that user. Such assignment can be based on a unique identifier associated with that individual, such as a user id, a user password, or based on other identifiers. As illustrated, the user 310 is assigned to a developer role 306 in the first repository 302 and a project manager 308 in the second repository 304.

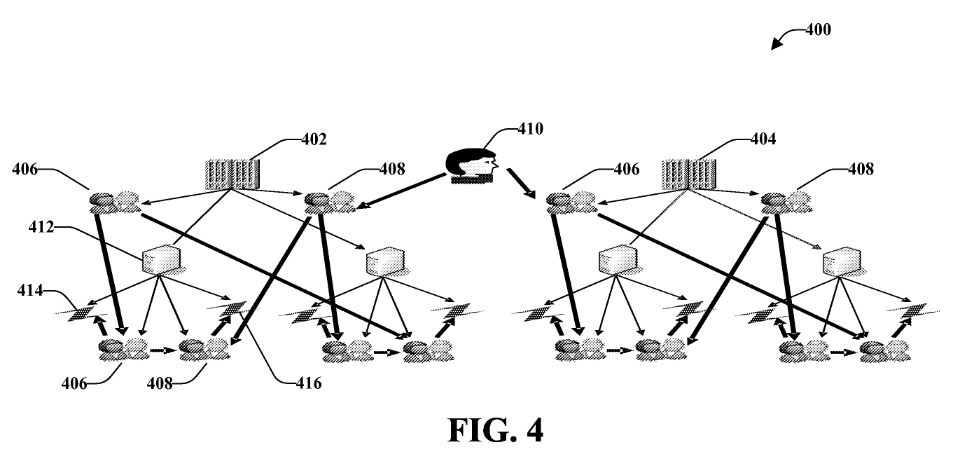

FIG. 4 illustrates an exemplary manual administration 400 of assigning access rights to a multitude of users. This example is similar to the above example and includes a first project 402 and a second project 404. A developer 406 and a project manager 408 are identified or associated with each project 402, 404. A user 410 might be responsible for the role of developer 408 in the first project and the role of project manager 406 in the second project 404.

However, when manually assigning roles 406, 408 to the associated projects 402 and 404 (e.g., without utilizing the disclosed embodiments), the roles 406, 408 cannot be utilized across the applications 402, 404. Therefore, further manual action is required to assign the roles and individuals to the projects 402, 404. In the following discussion, only one role will be described for purposes of simplicity. For manual administration, a server 412 is utilized for each role. Each user or group of users 406, 408 would be manually associated with one or more operations, such as an edit permission 414 and a read permission 416, for example. Each permission 414, 416 is manually associated with a user or group of users 406, 408, and for each role (e.g., developer 406 and project manager 408) the permission would have to be manually configured a multitude of times.

Manual configuration can lead to errors since there are so many configurations that need to be modified manually. Thus, the disclosed embodiments can mitigate repetitive manual effort of the administrator by providing modular roles that can be utilized across multiple projects. In addition, the disclosed embodiments can make it simple to determine a policy and its purpose after a long history of incremental changes (e.g., changes to access rights).

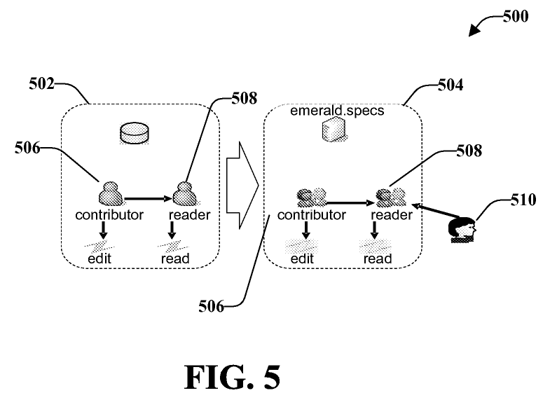

With reference now to FIG. 5, illustrated is an exemplary system 500 that can be utilized with the disclosed embodiments. The system can include a template, illustrated by dotted line 502, and an instance, illustrated by dotted line 504. The template 502 and its instance 504 can be referred to as a leaf scope that can correspond to an instance of a service and a subset of its resources. In addition to coding of the service, the scope template 502 is created that can define the roles for the service. A role can determine the permissions that a user can have when performing the functions of that role. The roles of FIG. 5 are illustrated as contributor 506 and reader or viewer 508. Each role 506, 508 can be tailored to enable a user or group of users to perform a task (e.g., bank teller, HR benefits clerk, contributor or viewer of documents, and so forth). In the example, the contributor 506 can edit documents and, as illustrated, can also be a viewer 508, which is an example of role nesting.

The predefined roles 506, 508 can help to determine a combination of permissions that should be tested to make sure they correctly enable the desired tasks and conform to an authorization policy within the scope. The scope template 502 is instantiated to create a scope. The same template 502 can be utilized to create many scopes, as illustrated in FIG. 5. In this illustration, the contributor 506 and viewer 508 roles have the same permissions for the resource in the scope that the corresponding role template had in the template. A user 510 is illustrated as being placed into the viewer role. Each scope can precisely mirror the scope template and has the resources, roles, and permissions defined in the template 502.

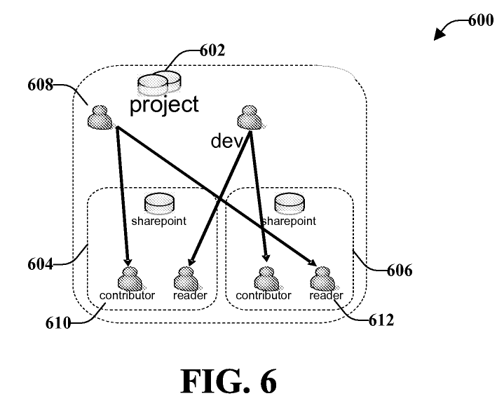

FIG. 6 illustrates another system 600 that can be utilized with the disclosed embodiments. Various program applications can be utilized to create higher-level templates. System 600 includes a project repository 602 that can include at least two subparts, illustrated as specifications 604 and sources 606. A project manager role 608 can be assigned to a contributor role 610 in the specification server 604 and a viewer or reader role 612 in the source server 606. A part's role can include the interface that it exports to containing scopes. The smallest parts are actual services and include composite parts, such as project contained subparts. These can be nested as deeply as needed to provide the various roles and sub-roles. Since this can be defined for all project repositories, an administrator simply instantiates the model without needing to understand all the details involved. Two instances of this project template would appear similar to the system illustrated in FIG. 3. Thus, smaller parts or sub-roles can be utilized to create larger roles without needing the multiple manual configurations described above.

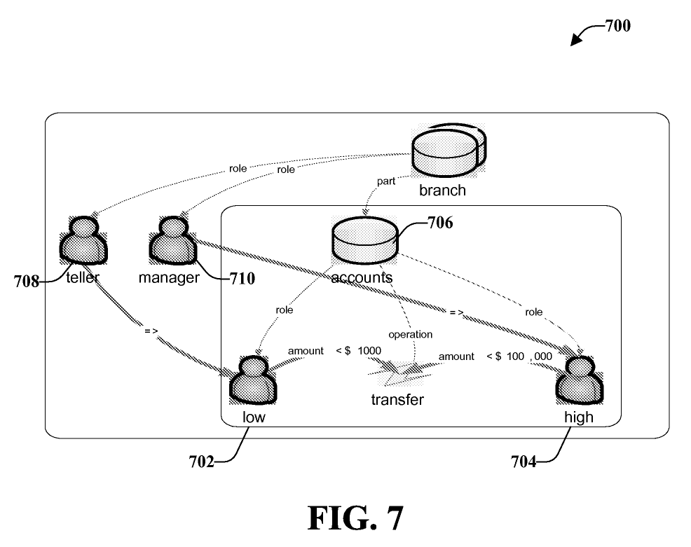

FIG. 7 illustrates the extensible nature of the disclosed embodiments. Illustrated is a template 700 for a bank teller application to demonstrate the extensible policy in a business application. A low role 702 and a high role 704 can be applied to accounts 706 that a bank services. Each role 702, 704 can have a corresponding permission to transfer amounts, such as $1000 for the low role 702 and $100,000 for the high role.

In an outer branch application a teller role 708 and a manger role 710 can be assigned to the low accounts and the high accounts, respectively. An administrator or other user responsible for assigning the roles can add to the application logic the amount value for the current transaction and a policy system can evaluate the express. Thus, the roles are modular and the policy can be updated through the model-based access control without changing the application code.

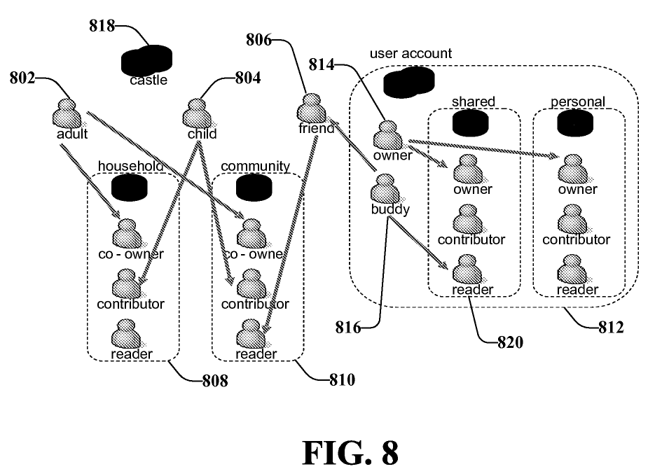

FIG. 8 illustrates a simplified template for a family personal computer or domain. Module-based access control can be utilized for enterprise applications and it can also make authorization less complicated for small businesses and consumers. It should be noted that FIG. 8 illustrates only a sub-portion of a family domain for purposes of simplicity.

A desktop for a single machine might have several predefined roles (e.g., abstract user models), such as an adult 802, a child 804, and a friend 806. Also included can be several predefined scopes, such as household 808, community 810, and a user scope template 812. These scopes 808, 810, 812 can be built from the same basic scope template. This scope template appears four times in the figure. Adult 802 can be an owner 814 and child 804 can be a contributor on the household scope 808 and the community scope 810. Each user can have a buddy list and buddies 816 are friends for the castle 818 and in addition are readers 820 on the user's shared sub-scope. It should be noted that this is a simple example and a small business can have several more parts.

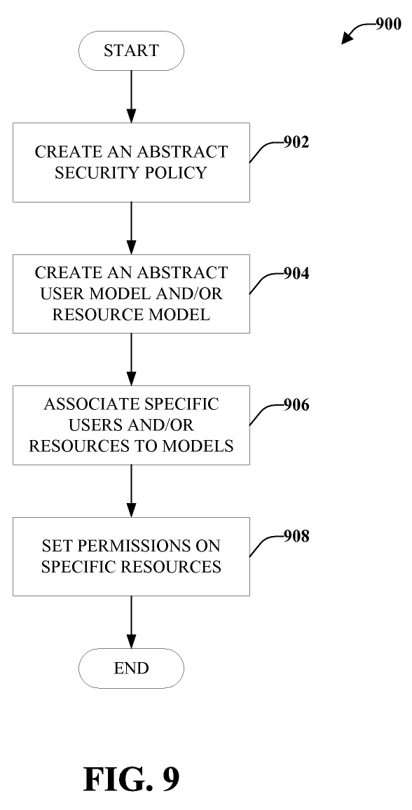

FIG. 9 illustrates a method 900 for providing a model based access control that is modular. While, for purposes of simplicity of explanation, the methodologies are shown and described as a series of blocks, it is to be understood and appreciated that the disclosed embodiments are not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

At 902, an abstract security policy is created. This security policy can be created in such a manner that it is independent from the type of mechanism or configuration actually used to protect resources (e.g., programs, applications, formats, files, and so forth). An abstract user model and/or an abstract resource model can be created or developed at 904. These models are not specific to a particular user and/or a particular resource but relates to different resources, roles or functions and the access control that should be authorized for various resources, users, or user roles.

At 906, specific users and/or specific resources are associated with one or more abstract user models or abstract resource models. For example, a user model might be for a supervisor that should have securities policies that relates to a subordinate's functions. In such a manner, the supervisor should be given the abstracted security policy for the supervisor and the abstracted security policy for the subordinate. In addition more than one user model can be associated with more than one abstract security policy by nesting the models in such a manner that the model can be specified for access control and that model can be used as a component in building models for bigger systems. The association, at 906, also allows for modularity in that the abstract user model and associated abstract security policy or abstract resource model can be used across applications or in different application.

Permissions (e.g., name specific users/groups with their rights) can be automatically set on specific resources based on the model, at 1008. In some embodiments more than one individual is associated with either or both the abstracted user model and the abstracted security policy.

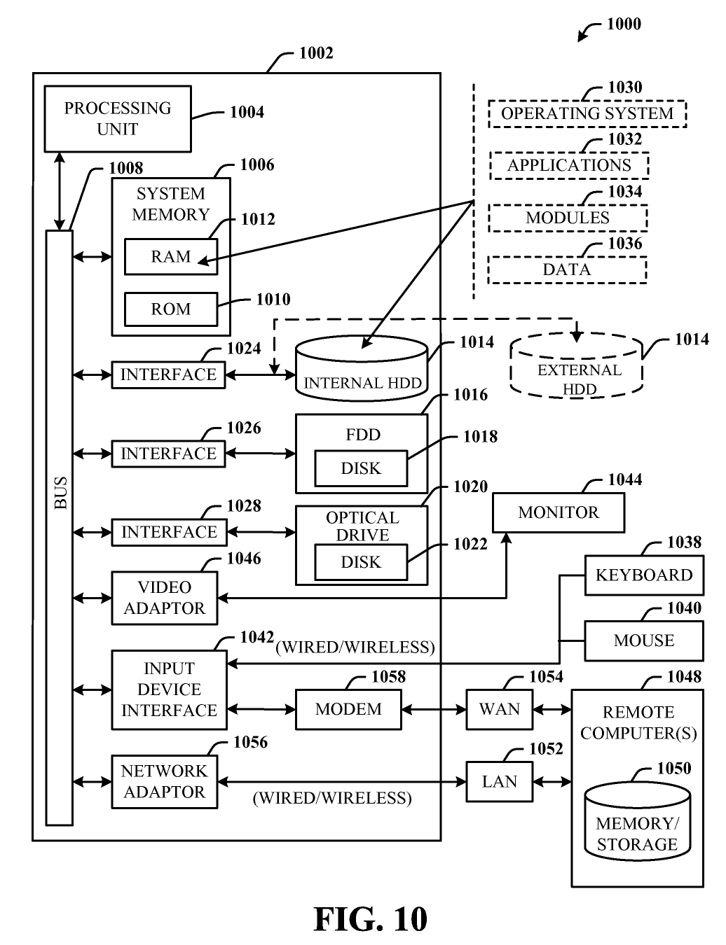

Referring now to FIG. 10, there is illustrated a block diagram of a computer operable to execute the disclosed architecture. In order to provide additional context for various aspects disclosed herein, FIG. 10 and the following discussion are intended to provide a brief, general description of a suitable computing environment 1000 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 13104 interface technologies. Other external drive connection technologies are within contemplation of the one or more embodiments.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the various embodiments can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 through an interface, such as a video adapter 1046. In addition to the monitor 1044, a computer typically includes other peripheral output devices (not shown), such as speakers, printers, etc.

The computer 1002 may operate in a networked environment using logical connections through wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 through the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

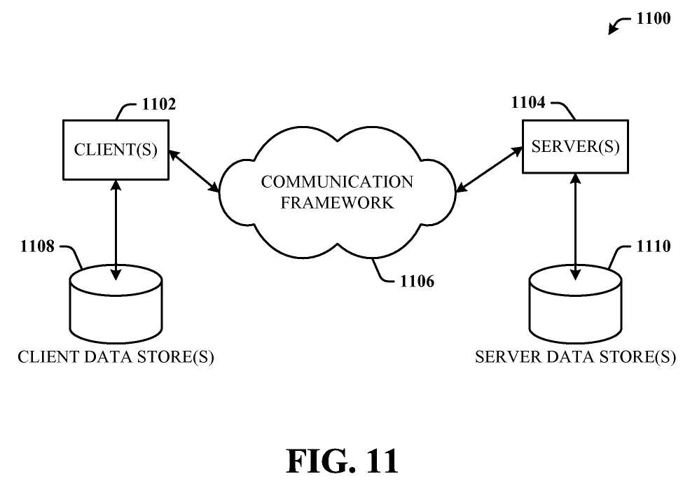

Referring now to FIG. 11, there is illustrated a schematic block diagram of an exemplary computing environment 1100 in accordance with the various embodiments. The system 1100 includes one or more client(s) 1102. The client(s) 1102 can be hardware and/or software (e.g., threads, processes, computing devices). The client(s) 1102 can house cookie(s) and/or associated contextual information by employing the various embodiments, for example.

The system 1100 also includes one or more server(s) 1104. The server(s) 1104 can also be hardware and/or software (e.g., threads, processes, computing devices). The servers 1104 can house threads to perform transformations by employing the various embodiments, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated through a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

What is claimed is:

1. A system that facilitates model-based access control, comprising:
an abstraction component (102, 202) that builds at least one abstract user model or abstract resource model or both;
an assignment component (104, 204) that correlates at least one specific user to the abstract user model and at least one specific resource to the abstract resource model; and
a permission component (106, 206) that automatically sets at least one permission on the specific resource based in part on the abstract resource model.

2. The system of claim 1, the abstraction component is independent of a mechanism used to protect resources.

3. The system of claim 1, the abstraction component preserves a policy intent.

4. The system of claim 1, the assignment component maintains information relating to a user role and its access permissions.

5. The system of claim 1, the abstraction component provides repeatability of a user role configuration.

6. The system of claim 1, the abstract user model and abstract resource model are modular and applied across different applications.

7. The system of claim 1, the permission component translates the abstract user model and abstract resource model into concrete terms.

8. The system of claim 1, the abstraction component provides a mechanism to specify the model in abstract terms.

9. The system of claim 1, a security policy is specified in a nested model.

10. The system of claim 9, the nested model allows the abstract user model and the abstract resource model to be specified for access control and used as a component in building models for larger systems.

11. The system of claim 1, the assignment component recognizes the specific user based on a unique identifier.

12. The system of claim 1, the permission component automatically creates an appropriate permission and membership when the user is identified with the model.

13. A method for providing a model based access control, comprising:
creating an abstract user model and an abstract resource model;
associating at least one specific user with the abstract user model;
associating at least one specific resource with the abstract resource model; and
setting at least one permission on the specific resource based in part on the abstract user role.

14. The method of claim 13, creating an abstract user model and an abstract resource model further comprising creating the models to be independent from a type of mechanism used to protect resources.

15. The method of claim 13, further setting at least one permission on the specific resource based in part on the abstract user role is automatic.

16. The method of claim 13, further comprising nesting the associated abstract user model.

17. The method of claim 13, creating an abstract user model and an abstract resource model provides modularity.

18. The method of claim 13, further comprising associating two or more individuals with the abstract user model and the abstract resource model.

19. A computer executable system that provides access control, comprising:
means for creating an abstract user model and an abstract resource model;
means for associating at least one user to the abstract user model and at least one resource to the abstract resource module.

20. The system of claim 19, further comprising means for applyingpermission on the at least one resource.
